(19) United States
(12) Patent Application Publication
(10) Pub. No.: US 2007/0204235 A1
(43) Pub. Date: Aug. 30, 2007

(54) Method for any ticker while the user is in any application session in a mobile communication device

(75) Inventors: Venkata Ramana Gudi, Bangalore (IN); Adappa Gourannavar, Bangalore (IN)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/702,827

(22) Filed: Feb. 6, 2007

(30) Foreign Application Priority Data
Feb. 6, 2006 (IN) 188/CHE/2006
Jan. 17, 2007 (KR) 2007-5312

(51) Int. Cl. G06F 3/048

(52) U.S. Cl. 715/774

(57) ABSTRACT

A method relating to the field of User Interface (UI), which aims to provide a mechanism to view a new message or any notification while any application is in progress or the user is in any session is provided. The method provides for displaying a ticker while the user is in any application session in a mobile communication device comprising registering a callback with the messaging module, which is called when a new message arrives; displaying the arrived new message in the form of a scrolling message or ticker on either the soft key area or on the annunciator bar area of the device; and continuing the current application by the user while the new message is scrolled or shown as ticker.

### PRIORITY

This application claims priority to an application entitled “A METHOD FOR ANY TICKER WHILE THE USER IS IN ANY APPLICATION SESSION IN A MOBILE COMMUNICATION DEVICE” filed with the Indian Patent Office on Feb. 6, 2006 and assigned Serial No. 188/CHE/2006, and entitled “A METHOD FOR ANY TICKER DISPLAY WHILE THE USER IS IN ANY APPLICATION SESSION IN A MOBILE COMMUNICATION DEVICE” filed with the Korean Property Intellectual Property Office on Jan. 17, 2007 and assigned Serial No. 2007-5312, the entire disclosure of which is incorporated herein by reference.

### BACKGROUND OF THE INVENTION

1. Field of the Invention

The present invention, in general, relates to mobile communication devices. Particularly, this invention relates to the field of User Interface (UI) which aims to provide a mechanism to view the just arrived message or any notification while any user application is in progress or a user is in any session. More particularly, the invention relates to a method for any ticker while the user is in any application session in a mobile communication device.

2. Description of the Related Art

The current technology does not provide for viewing a message while any user application is in progress or a user is in any session without closing the current application or session.

For example, if the user is engaged in any application, like watching an interesting video clipping or playing a java game, or the user is in a different session on the communicating device and there is a message or notification received by the device, currently, the user has to close the current application or session to view the received message or notification Otherwise, the user can view the message or notification after his current activity is finished.

If the user is engaged in any application, like watching an interesting video clipping or playing a java game, or the user is in a different session on the handset and a message or notification arrived at the device or it is in his inbox, he would be curious to know from whom the message came or if is it something urgent. As a result, the excitement with which the user was watching the video fades away, and the user has to stop the video in order to read the message.

### SUMMARY OF THE INVENTION

An object of the invention aims at enabling the user to view a just arrived message (i.e. SMS, MMS text, Email, etc.) or notification when the user is in the middle of any interesting application like watching video clip or playing a game or the user is in a different session.

Another object of the invention is to enable applications to display message or notification without exiting the current application.

A further object of this invention enables a user to view the message or notification on or above the soft key area or on top of the annunciator bar depending on the type of application he/she is in now. Therefore, the user will be able to continue executing the current application or session uninterrupted, without missing some urgent information.

According, to an aspect of this invention, a method displays a ticker while the user is in an application session in a mobile communication device.

According to another aspect of the present invention, the method registers a callback with the messaging module, which is called when a new message arrives.

According to a further aspect of the present invention, the method displays the arrived new message in the form of a scrolling message or ticker on either the soft key area or on the annunciator bar area of the device.

According to yet another aspect of the present invention, the method continues the current application by the user while the new message is scrolled or shown as a ticker.

The present invention provides a method whereby, a callback takes care of the changes in the User Interface (UI) if the application is in progress. The user can decide to either continue the current application or stop the application in order to reply to the incoming message. If the user chooses to ignore the incoming message, he switches off the scroll or ticker by pressing the clear key. If the incoming message happens to be a Multi-Media Messaging Service (MMS), only the notification is displayed, and based on the requirement, the user can decide to stop the current application and download the MMS or continue in the current application. The incoming message or notification can be in any format and the message or notification is viewed irrespective of display mode. The message can be displayed irrespective of any language mode and can be scrolled in any direction on the display device. The scroll or ticker can be controlled in plurality of ways through any input device and the received message can be stored in the device. The message or notification can be scrolled on any part of the display irrespective of any application in progress where the application or session is either triggered manually by the user or automatically triggered by the device but will be similarly controlled. The display device can be internal or external to the communication device and can be a fixed, flexible or rotatable one. Communicating device maintains display status as idle or used by an application or session to determine how to display incoming message or notification and if the display is an idle state, the message is displayed in Message application window. The user sets the display status ON or OFF to view message or notification in scrolling manner irrespective of the application or session in progress.

### BRIEF DESCRIPTION OF THE DRAWINGS

The above and other objects, features and advantages of the present invention will become more apparent from the ensuing detailed description of the invention taken in conjunction with the accompanying drawings, in which

FIG. 1 is a flow chart describing the steps, which enable viewing of new message while an application is in progress;

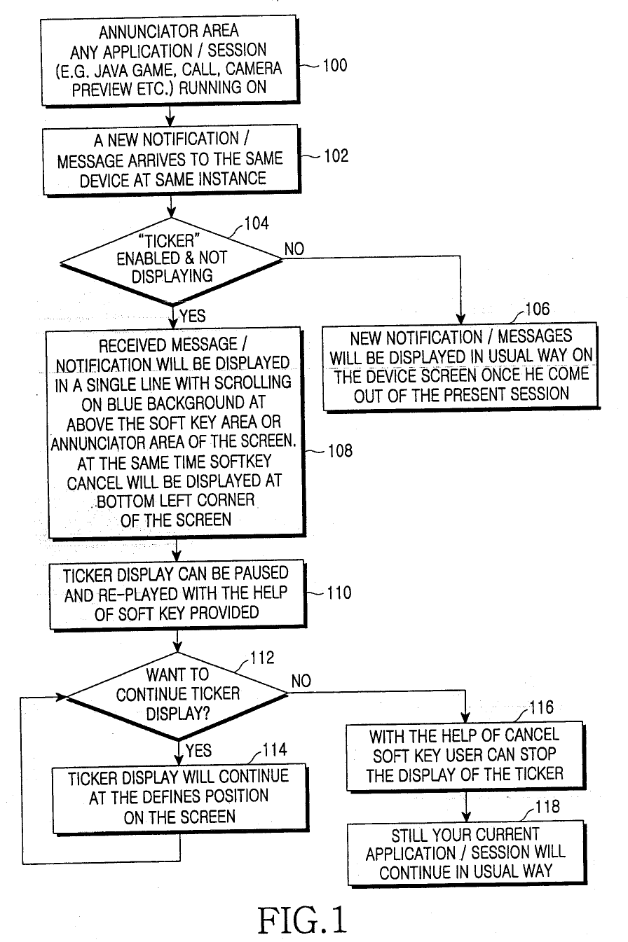

FIGS. 2A, 2B and 2C depict screen display when the message arrives.

### DETAILED DESCRIPTION OF PREFERRED EMBODIMENTS

The preferred embodiments of the present invention will now be explained with reference to the accompanying drawings. It should be understood however, that the disclosed embodiments are merely exemplary embodiments of the invention, which may be implemented in various forms. The following description and drawings are not to be construed as limiting the invention and the specific details are provided for a thorough understanding of the present invention, as the basis for the claims and as a basis for teaching one skilled in the art how to practice the invention. However in certain instances, well-known or conventional details are omitted in order not to unnecessarily obscure the present invention in detail.

When any application like video streaming or java game is in progress or a user is in a different session in step 100, it occupies the edit area of the screen. Now, when the message arrives in step 102, a mobile communication device determines whether Ticker is enabled or not in step 104. And if Ticker is not enabled, new notification/messages will be displayed in a usual way on the device screen once the user exits out of the present session in step 106.

And if Ticker is enabled, depending on the type of application, the notification/message can be displayed in a scrolling fashion (or ticker) on or above the soft key area or on the annunciator bar area in step 108. The Ticker display can be paused and re-played with the help of a soft key provided in step 110. A mobile communication device determines whether a user wants to continue the Ticker display or not in step 112. If the user wants to continue the Ticker display, the Ticker display will continue at a previously defined position on the screen in step 114. However, if the user doesn't want to continue the Ticker display, with the help of a CANCEL soft key, the user can stop the display of the ticker in step 116, and the current Application/session will continue in the usual way in step 118.

It should be noted that the host for storing the applications includes but is not limited to a microchip, microprocessor, handheld communication device, computer, rendering device or a multi function device.

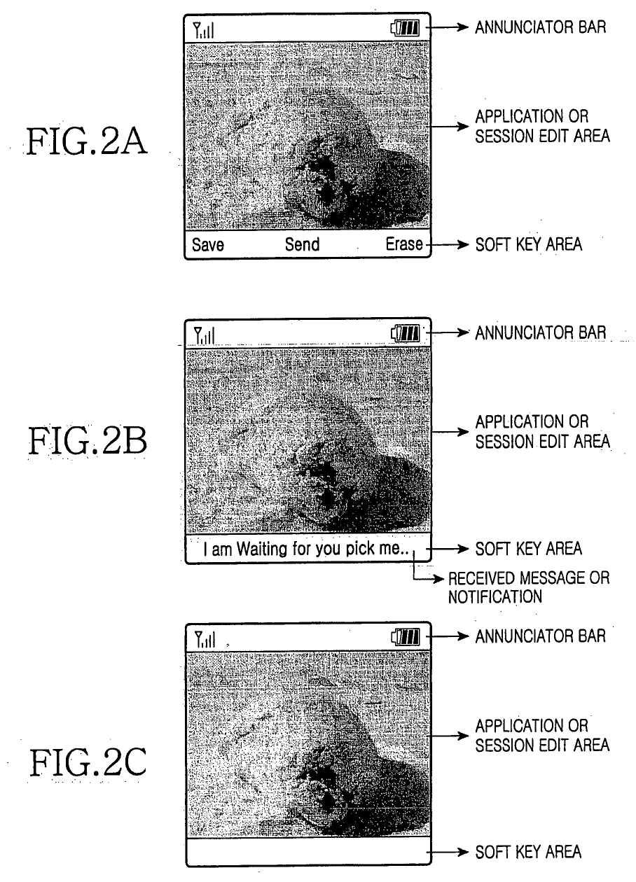

Referring to FIG. 2A, before viewing the message, a callback would be registered with the messaging module, which would be called when a new message arrives, if the application is in progress the callback would take care of the changes in the user interface (UI). The new message will now be displayed in the form of a scrolling message (or ticker) on either the soft key area or on the annunciator bar area. The user can opt to remain in the current application while the new message is scrolled or exit in order to reply to the incoming message. If he chooses to ignore the incoming message, he switches off the scroll (or ticker) by pressing the clear key.

If the incoming message happens to be a MMS, only the notification will be displayed. Based on need, the user can decide to exit the current application and download the MMS or continue in the current application.

Referring to FIG. 2B and while viewing the message and FIG. 2C

After viewing the message, the advantages of these two aspects of the invention are described next. The main advantage of the invention is that the user need not have to stop the application in between to view the arrived message. With the invention the user will not miss any important message, which may be neglected if the user so chooses. It will also be obvious to those skilled in the art that other control methods and apparatuses can be derived from the teachings of the present invention as disclosed by the description and the accompanying drawings and these shall also be considered within the scope of the present invention.

Although the present invention has been fully described in connection with the preferred embodiments thereof with reference to the accompanying drawings, it is to be noted that various changes and modifications are possible and are apparent to those skilled in the art. Such changes and modifications are to be understood as included within the scope of the present invention as further defined by the appended claims.

1. A method for displaying a ticker while a user is in an application session in a mobile communication device comprising:
(a) registering a callback with a messaging module, which is called when a new message or notification arrives;
(b) displaying the arrived new message in the form of a scrolling message or ticker on soft key area of the device; and
(c) continuing the current application by the user while the new message is scrolled or shown as a ticker.

2. The method as in claim 1, wherein the new message is displayed on an enunciator bar.

3. The method as in claim 1, wherein if the application is in progress the callback takes care of the changes in a User Interface (UI).

4. The method as in claim 1, wherein the user can decide to either continue in the current application or exit the application in order to reply to the incoming message.

5. The method as in claim 1, wherein if the user chooses to ignore the incoming message, the user switches off the scroll or ticker by pressing a clear key.

6. The method as in claim 1, wherein if the incoming message is a Multi-Media Service (MMS) message, only the notification is displayed and the user can decide to stop the current application and download the MMS or continue in the current application.

7. The method as in claim 1, wherein the incoming message or notification can be in any format and the message or notification is viewed irrespective of a display mode.

8. The method as in claim 1, wherein the message can be displayed irrespective of any language mode and can be scrolled in any direction on a display device.

9. The method as in claim 1, wherein the scroll or ticker can be controlled in plurality of ways through any input device and the received message can be stored in the device.

10. The method as in claim 1, wherein the message or notification can be scrolled on any part of the display irrespective of any application in progress where the application or session is either triggered manually by the user or automatically triggered by the device but is similarly controlled.

11. The method as in claim 8, wherein the display device can be located anywhere with respect to the communication device and can be one of a fixed, flexible or rotatable one.

12. The method as in claim 1, wherein the communication device maintains a display status as idle or used by an application or a session to determine how to display the incoming message or notification.

13. The method as in claim 1, wherein the message is displayed in a message application window if the display state is the idle state.

14. The method as in claim 1, wherein the user sets a display status ON or OFF to view the message or notification in a scrolling manner irrespective whether an application or session is in progress.
